(19) United States
(12) Patent Application Publication
(10) Pub. No.: US 2001/0006472 A1
(43) Pub. Date: Jul. 5, 2001

(54) Data read/write unit capable of adjusting the transmission speed of read/write data

(76) Inventor: Hiroyuki Okano, Ibaraki (JP)

Correspondence Address: McGinn & Gibb, PLLC, Suite 200, 8321 Old Courthouse Road, Vienna, VA, 22182-3817, US

(21) Appl. No.: 09/750,344

(22) Filed: Dec. 29, 2000

(30) Foreign Application Priority Data
Jan. 5, 2000 (JP) 230/2000

(51) Int. Cl. G11B 5/09

(52) U.S. Cl. 365/33; 360/51

(57) ABSTRACT

A magnetic tape unit is provided which performs a read/write operation in a precise timing by regularly using a reference tape on which a reference signal is written. The magnetic tape unit, which transmits data to a magnetic tape drive based on a predetermined clock signal and writes or reads data to or from a magnetic tape, includes means for changing a data transmission timing in which the data is transmitted.

### BACKGROUND OF THE INVENTION

1. Field of the Invention

The present invention relates to a data read/write unit, and more particularly to a data read/write unit capable of adjusting the transmission speed of read/write data according to the running speed of a data-recording medium.

2. Description of the Related Art

A data read/write unit, such as a magnetic tape unit, reads or writes data with both the speed of a data-recording medium and the speed of data transmission to a data-recording medium set to a predetermined speed. More specifically, the data read/write unit writes or reads data to or from a recording medium on the assumption that the drive driving the data-recording medium runs at a speed conforming to the speed specified for the data-recording medium and that the controller converting the format of write data runs at a speed conforming to the speed specified for data transmission.

The problem is that the data transmission speed of the controller described above, once set at a factory during manufacturing, is not readjusted. This means that write data is always sent to the drive at the speed defined by the design specification.

However, a change in the ambient operating conditions such as the temperature or humidity or a change with age sometimes varies the data-recording medium speed. In such a case, the transmission of control data or user data to the drive is not well timed with the result that more read errors will occur.

In addition, when the drive running speed varies from the original design speed or the factory-set speed, the writing of data onto the data-recording medium is not well-timed. A need therefore exists for adjusting the data transmission speed or the drive running speed so that data may be read or written according to the status of the drive.

### SUMMARY OF THE INVENTION

In view of the foregoing, it is an object of the present invention to provide a data read/write unit which regularly uses a reference data-recording medium, on which the reference signal is recorded in the precise timing, to match the speed of data transmission to the drive with the running speed of a data-recording medium for reading or writing data in the precise timing.

To solve the above problems, the data read/write unit according to the present invention, which transmits data to a data-recording medium drive based on a predetermined clock signal and writes or reads data to or from a data-recording medium, comprises a data transmission timing changing unit which changes a timing in which the data is transmitted.

The data transmission timing changing unit of the data read/write unit according to the present invention comprises a timing checking circuit which checks if the data is written in the drive in a predetermined timing; and a clock frequency changing circuit which changes a frequency of the clock signal based on a judgment made by the timing check circuit.

This configuration allows the data transmission speed to be adjusted to the running speed of the drive even if the running speed of a data-recording medium varies because of a change in the ambient operating environment or some other reason. This enables data to be written in a precise timing, thus preventing read errors.

The timing checking circuit of the data read/write unit according to the present invention creates correction data for changing the frequency of the clock signal based on the judgment, and the frequency changing circuit changes the frequency of the clock signal based on the correction data.

The data transmission timing changing unit of the data read/write unit according to the present invention further comprises memory means for temporarily storing the correction data. The memory means is a flash memory or a register.

A register, when used as the memory means, is connected to a host unit of the data read/write unit, and the correction data created by the timing checking circuit may be saved in the host unit. When the data read/write unit is started, the correction data saved in the host unit may be read for setting the frequency of the clock signal.

This configuration allows the host unit to set the data transmission speed (clock signal frequency) that matches the running speed of the drive, making it possible to connect a non-basic running speed drive without having to change the data read/write unit hardware (for example, controller). Conventionally, when the running speed of the recording medium differs from the factory-set speed, the clock signal frequency must be changed. More specifically, the oscillator or the clock frequency divider circuit must be replaced. The data read/write unit according to the present invention enables the host system to change the clock signal frequency to allow one controller to be used with a plurality of types of drives.

The data read/write unit according to the present invention reads data on a reference data-recording medium on which a reference signal is recorded in a precise timing. The timing checking circuit compares the data that was read with a standard value and, based on the comparison, checks to see if the data is written in the predetermined timing.

Thus, by comparing the reference signal on the reference data-recording medium with the standard value, the data transmission timing may be checked. Therefore, even if only the data transmission speed is different from the factory-set speed, it may be restored to the factory-set speed though this timing checking. This allows data to be transmitted in the timing conforming to the specification, increasing the reliability of the data read/write unit.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying, wherein:

FIG. 1 is a block diagram showing the configuration of a magnetic tape unit in a first embodiment of the present invention;

FIG. 2 is a flowchart showing how the clock is adjusted in the magnetic tape unit shown in FIG. 1;

FIG. 3 is a block diagram showing the configuration of a magnetic tape unit in a second embodiment of the present invention; and

FIG. 4 is a diagram showing the configuration of data written on a tape of the magnetic tape unit of the present invention.

### DESCRIPTION OF THE PREFERRED EMBODIMENTS

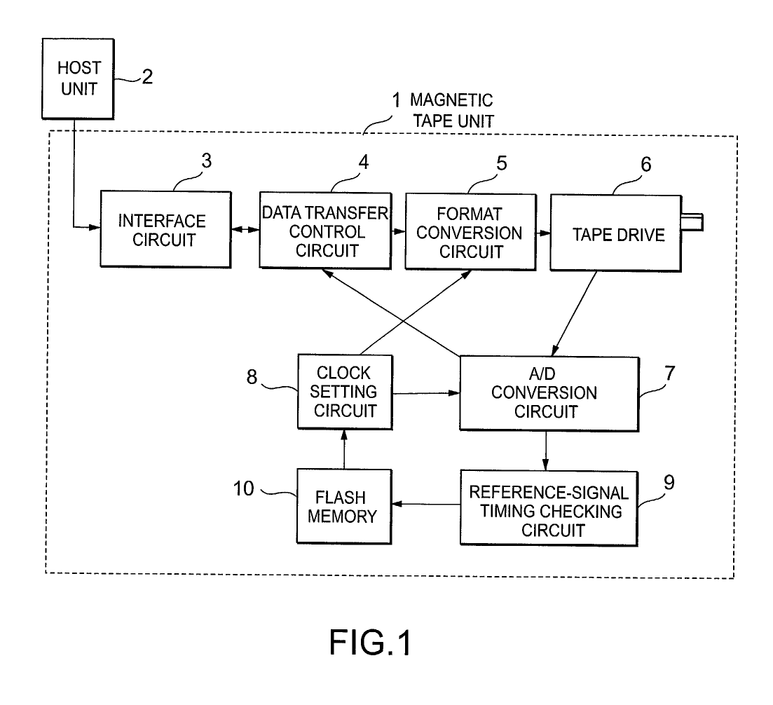

Some embodiments of the present invention will be described in detail by referring to the attached drawings. FIG. 1 is a block diagram showing the configuration of a magnetic tape unit used in a first embodiment of the present invention. Referring to FIG. 1, a magnetic tape unit 1, connected to a host unit 2, comprises an interface circuit 3 which controls connection to the host unit 2 and transfers data therewith, a data transfer control circuit 4 which compresses data from the interface circuit 3, attaches an error check code to the data, and buffers the data, a format conversion circuit 5 which converts data output from the data transfer control circuit 4 into a format in which data may be recorded on a magnetic tape (not shown in the figure), a tape drive 6 which writes or reads data to or from the magnetic tape, an A/D conversion circuit 7 which converts data read from the magnetic tape from analog to digital, a clock setting circuit 8 which establishes the timing in which data is written or read to or from the magnetic tape, a reference-signal timing checking circuit 9 which, when reading a reference tape on which the reference signal is recorded in a precise timing, checks if the data read/write timing is correct and creates clock-signal frequency change data, and a flash memory 10 in which clock-signal frequency correction data created by the reference-signal timing checking circuit 9 is temporarily stored.

The timing checking circuit 9, which runs only when the timing of the magnetic tape unit 1 is adjusted with the use of the reference tape described above, measures the clock signal length of a recording data block detected by the A/D conversion circuit 7. Then, the circuit compares the signal length with the standard length to check if the measured signal length is within the allowable range. In this case, the circuit measures the signal length of the recording data block based on the clock signal frequency set by the clock setting circuit 8.

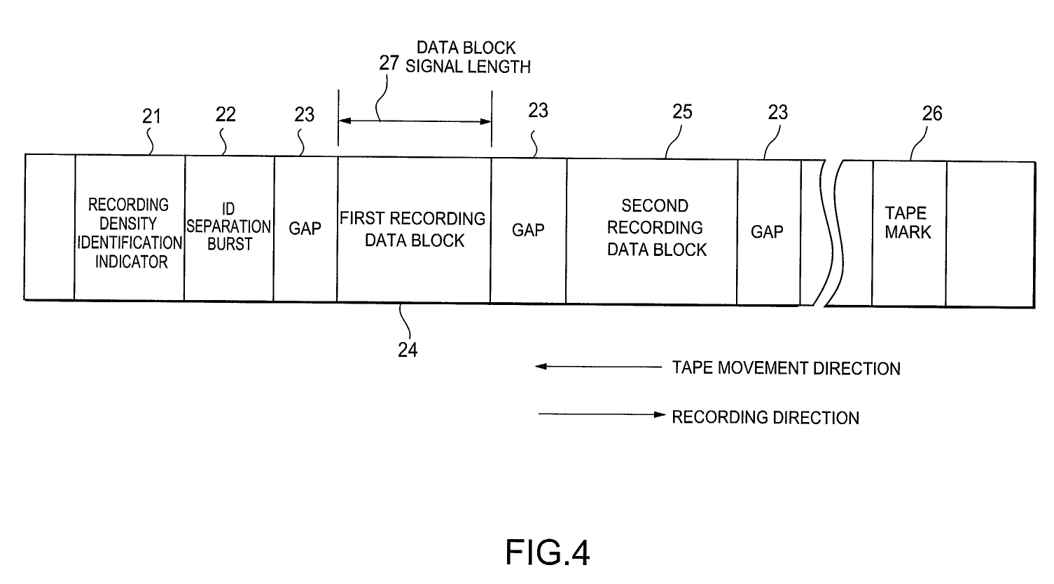

FIG. 4 shows an example of the configuration of a magnetic tape used for the present invention. This tape conforms to the standard defined by JIS X6124-1990 or ANSI. This magnetic tape has, on its recording surface, a recording density identification burst 21 indicating the recording density, an ID separation burst 22 indicating the ID of the magnetic tape, gaps 23, a first recording data block 24, a second recording data block 25, . . . , an Nth recording data block (not shown in the figure), and a tape mark 26.

The reference tape described above is a tape which contains, for example, all 1s (FF in hexadecimal) in a plurality of recording blocks beginning with the first recording data block 24. Although data of all 1s is used, any value other than 1 may be stored in those blocks. A recording-data-block signal length 27 refers to the length of time from one end of a recording data block to the other end thereof.

Based on the checking described above, the timing checking circuit 9 records and saves clock signal correction data into the flash memory 10. The clock setting circuit 8 references the correction data recorded in the flash memory 10 and changes the frequency of the clock signal defining the data read/write timing to adjust the magnetic tape unit operation timing. This adjustment is made if the reference-signal timing checking circuit 9 finds that the length of the reference signal of the reference tape, read by the tape drive 6, is out of the allowable range of the standard value.

The clock setting circuit 8 is easily implemented by a variable frequency oscillator or a synthesizer that generates signals with a frequency dependent on the incoming digital values. This art is well known and therefore its description is omitted.

When the signal length of the reference signal is within the allowable range of the standard value, the clock setting circuit 8 does not change the clock signal. However, when the signal length is out of the allowable range of the standard value, the clock setting circuit 8 changes the frequency of the clock signal.

Next, the operation of this embodiment will be described. The magnetic tape unit 1, which is connected to the host unit 2 via the interface circuit 3, transfers instructions and user data to or from the host unit 2.

When writing data on a magnetic tape, the data transfer control circuit 4 receives data to be written on the magnetic tape from the host unit 2 via the interface circuit 3. This data includes control data such as marks and user data. Upon receiving the data, the data transfer control circuit 4 compresses, attaches error check codes to, and buffers the data. The format conversion circuit 5 receives the data from the data transfer control circuit 4, converts it to a format that may be written on a magnetic tape, and sends the converted data to the tape drive 6 where data is written onto the magnetic tape.

On the other hand, when reading data from the magnetic tape, the tape drive 6 first reads data. The A/D conversion circuit 7 converts the data to digital signals and sends the converted signals to the data transfer control circuit 4. The data transfer control circuit 4 checks the data for an error, decompresses it, and then sends it to the host unit 2 via the interface circuit 3.

It should be noted that the timing in which the format conversion circuit 5 sends data to the tape drive 6 and in which the A/D conversion circuit 7 receives data from the tape drive 6 and sends it to the data transfer control circuit 4 is determined by the clock signal set up by the clock setting circuit 8. This clock signal is set up so that the writing of data synchronizes with the magnetic tape running speed.

However, various factors described above sometimes cause a difference between the data writing speed and the magnetic tape running speed. To adjust this difference, the data read/write unit according to the present invention changes the frequency of the clock signal regulating the timing in which the format conversion circuit 5 sends data and the timing in which the A/D conversion circuit 7 reads data.

More specifically, when the difference from the standard value in tape running speed is out of the allowable range, the adjustment is made as described below. If the tape running speed is lower than the standard speed, the data transmission speed is decreased the same degree. That is, the data transmission speed is set approximately to the reference data transmission speed (clock frequency) multiplied by the ratio of the running speed to the standard running speed. Similarly, if the tape running speed is higher than the standard speed, the data transmission speed is increased the same degree. That is, the data transmission speed is set approximately to the reference data transmission speed (clock frequency) multiplied by the ratio of the running speed to the standard running speed.

For example, when correction data is signed eight-bit data, assume that a variation of up to ±20% of the standard value of the signal length is to be corrected. In this case, an increase or a decrease of 1 in the correction data value results in an increase or a decrease of about 50K Hz when the standard clock frequency of the output clock signal is 31M Hz.

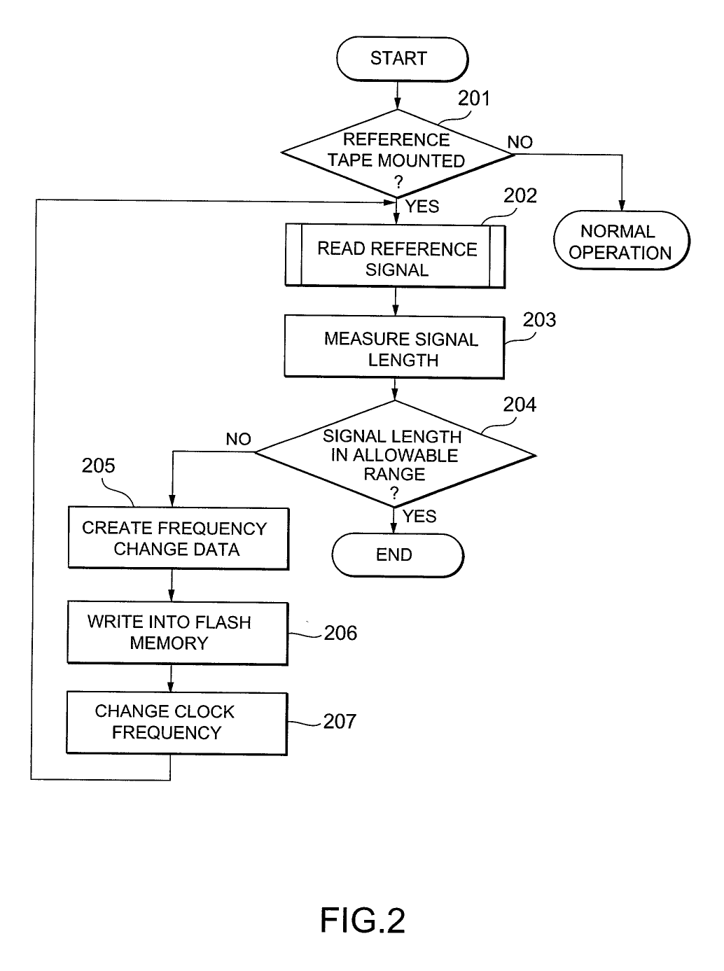

The adjustment of the clock signal will be described below. FIG. 2 is a flowchart showing how the clock signal of the magnetic tape unit 1 is adjusted. First, a check is made if the reference tape is mounted on the tape drive 6. If the reference tape is mounted (YES in step 201), data is read from this reference tape (step 202).

Next, the A/D conversion circuit 7 measures the signal length of the reference signal read from the reference tape (step 203) and compares the signal length with the predetermined standard value (step 204). If the signal length of the reference signal is within the allowable range, that is, if the difference from the standard value is within the predetermined allowable range (YES in step 204), the clock frequency is not changed and the frequency adjustment processing is finished. In this case, the allowable range is assumed to be, for example, ±1 to 2% from the standard value.

If the signal length of the reference signal is out of the allowable range (NO in step 204), the reference-signal timing checking circuit 9 creates correction data for changing the clock signal frequency (step 205). At this time, correction data is created so that the clock signal frequency is approximately the data transmission speed (clock frequency) multiplied by the ratio of the running speed to the standard running speed. This correction data is written into the flash memory 10 (step 206). The clock setting circuit 8 references this correction data to change the clock signal frequency (step 207). Next, the reference signal is read again and the check is made if the signal length of the reference signal is within the allowable range (steps 202-204). If the signal length is within the allowable range, clock adjustment is finished; otherwise, the checking process is repeated.

When the reference signal is read again to check the signal length, the clock signal from the clock setting circuit 8 is used. For example, the signal length is checked by counting the number of signal clocks for the data block length. Because the drive running speed is proportional to the corrected frequency of the clock signal, the signal length is expected to be in the allowable range when the reference signal is read again.

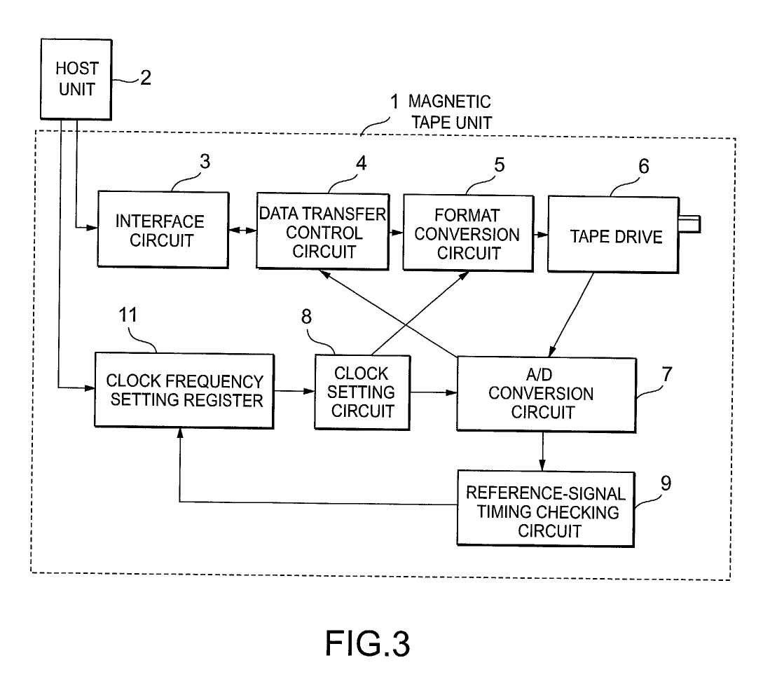

FIG. 3 is a block diagram showing the configuration of a magnetic tape unit used in a second embodiment of the present invention. As shown in FIG. 3, the magnetic tape unit in the second embodiment has a clock frequency setting register 11, in place of the flash memory 10, as means for storing clock frequency correction data. This clock frequency setting register 11 is connected directly to the host unit 2 to allow correction data to be transferred between the clock frequency setting register 11 and the host unit 2.

The configuration of other components, data read/write operation, and timing check operation during clock signal adjustment are the same as those in the first embodiment. Therefore, their description is omitted here.

In the second embodiment, correction data for changing the clock signal frequency is written in the clock frequency setting register 11 when the clock signal is adjusted. This correction data may be sent to the host unit 2 and saved there.

Therefore, next time the magnetic tape unit 1 is started, correction data stored in the host unit 2 may be sent to the clock frequency setting register 11 for setting the initial value of the operation clock frequency for use by the format conversion circuit 5 and the A/D conversion circuit 7. This value, which is set as the initial value of the magnetic tape unit 1, is used for reading the reference tape next time. Therefore, a timing check should be made thereafter to feedback information about the actual operating environment (for example, power voltage, operating environment, condition of each drive) The configuration of this embodiment allows the clock signal frequency suitable for a particular tape drive to be set from the host unit even if the tape drive with a non-basic speed is connected.

Although, a magnetic tape is used as a unit to which the present invention is applied in the above embodiments, the present invention may apply not only to a magnetic tape but also to other data read/write units such as an optical disc unit.

As described above, the data read/write unit according to the present invention adjusts the clock signal frequency with the use of the reference tape even if the running speed of the drive varies from the running speed set up during designing or manufacturing, thus preventing a difference in the timing in which user data is sent or in which data is written.

In addition, storing clock-signal-frequency change data in the host unit allows the clock frequency of a drive with a different running speed to be set up, making it possible to connect a drive with a non-basic running speed. That is, conventionally, when the running speed of the drive is different from the speed at which data is written, the hardware must be changed to change the clock frequency. The data read/write unit according to the present invention allows the common controller (format conversion circuit) to accommodate a plurality of types of drives by simply changing the clock frequency setting from the host unit.

While this invention has been described with reference to illustrative embodiments, this description is not intended to be construed in a limiting sense. Various modifications of the illustrative embodiments as well as other embodiments of the invention, will be apparent to persons skilled in the art upon reference to this description. It is, therefore, contemplated that the appended claims will cover any such modifications or embodiments as fall within the true scope of the invention.

What is claimed is:

1. A data read/write unit which transmits data to a data-recording medium drive based on a predetermined clock signal and writes or reads data to or from a data-recording medium, comprising:
a data transmission timing changing unit which changes a timing in which the data is transmitted.

2. The data read/write unit according to claim 1, wherein said data transmission timing changing unit comprises:
a timing checking circuit which checks if the data is written in said drive in a predetermined timing; and
a clock frequency changing circuit which changes a frequency of the clock signal based on a judgment made by said timing check circuit.

3. The data read/write unit according to claim 2, wherein said timing checking circuit creates correction data for changing the frequency of the clock signal based on the judgment and said frequency changing circuit changes the frequency of the clock signal based on the correction data.

4. The data read/write unit according to claim 3, wherein said data transmission timing changing unit further comprises memory means for temporarily storing the correction data.

5. The data read/write unit according to claim 4, wherein said memory means is a flash memory.

6. The data read/write unit according to claim 4, wherein said memory means is a register.

7. The data read/write unit according to claim 6, wherein said register is connected to a host unit of said data read/write unit and the correction data created by said timing checking circuit may be saved in the host unit.

8. The data read/write unit according to claim 7, wherein when said data read/write unit is started, the correction data saved in the host unit is read for setting the frequency of the clock signal.

9. The data read/write unit according to one of claims 1-8, wherein data on a reference data-recording medium on which a reference signal is recorded in a precise timing is read and said timing checking circuit compares the data that was read with a standard value and, based on the comparison, checks if the data is written in the predetermined timing.

10. A data read/write unit which transmits data to a data-recording medium drive based on a predetermined clock signal and writes or reads data to or from a data-recording medium, comprising:
means for changing a timing in which the data is transmitted.

11. The data read/write unit according to claim 10, wherein said means for changing a timing in which the data is transmitted comprises:
a timing checking circuit which checks if the data is written in said drive in a predetermined timing; and
a clock frequency changing circuit which changes a frequency of the clock signal based on a judgment made by said timing check circuit.

12. The data read/write unit according to claim 11, wherein said timing checking circuit creates correction data for changing the frequency of the clock signal based on the judgment and said frequency changing circuit changes the frequency of the clock signal based on the correction data.

13. A magnetic tape unit which transmits data to a magnetic tape drive based on a predetermined clock signal and writes or reads data to or from a magnetic tape, said magnetic tape unit being connected to a host unit, comprising:
an interface circuit which controls connection to the host unit and transfers data therewith;
a data transfer control circuit which compresses data from said interface circuit, attaches an error check code to the data, and buffers the data;
a format conversion circuit which converts the data output from said data transfer control circuit into a format in which the data may be recorded on a magnetic tape;
a tape drive which writes or reads data to or from a magnetic tape;
an A/D conversion circuit which converts data read from a magnetic tape from analog to digital;
a clock setting circuit which establishes a timing in which data is written or read to or from a magnetic tape;
a reference-signal timing checking circuit which, when reading a reference tape on which a reference signal is recorded in a precise timing, checks if the data read/write timing is correct and creates clock-signal frequency change data; and
a flash memory in which the clock-signal frequency correction data created by said reference-signal timing checking circuit is temporarily stored.
